(19) United States
(12) Patent Application Publication
(10) Pub. No.: US 2012/0036699 A1
(43) Pub. Date: Feb. 16, 2012

(54) HEIGHT SAFETY SYSTEM AND METHOD OF INSTALLATION

(75) Inventors: Peter Payne, New South Wales (AU); Mark Elkins, New South Wales (AU)

(73) Assignee: Safety Comploance Design & Services Pty Ltd., New South Wales (AU)

(21) Appl. No.: 13/256,172

(22) PCT Filed: Mar. 12, 2010
(86) PCT No.: PCT/AU10/00281

§ 371 Date: Nov. 2, 2011

(30) Foreign Application Priority Data
Mar. 12, 2009 (AU) 2009901101

(51) Int. Cl. B23P 11/00

(52) U.S. Cl. 29/428; 29/700

(57) ABSTRACT

A method of installing a height safety system in a fall zone in an underground location is described including the steps of: fitting an anchor point to at least one roof bolt situated above the fall zone; providing a safety line; associating the line with the anchor point; and attaching the line to an operator. Apparatus for use in installing height safety systems are also described.

### TECHNICAL FIELD

The present invention relates to a height safety systems and to methods of their installation. The invention finds a particular application in installing fall restraint systems in underground mining applications but is not limited to this use.

### BACKGROUND TO THE INVENTION

When working at a height there is a risk of injury to workers from falling. In underground mining facilities workers are often required to perform work on power cables, air lines and communications lines and the like which are suspended from the roof of the mine. The workers often have to climb between 1 to 5 metres off the ground to perform this work. Further, a worker will often use whatever objects are in the vicinity to climb up on such as drums, lengths of timber, or by climbing up on mining machinery such as a mine vehicle.

There is a significant risk of injury posed to workers working at height and there is a need to improve safety of these workers.

### SUMMARY OF THE INVENTION

In a first aspect the present invention provides a method of installing a height safety system in a fall zone in an underground location including the steps of: fitting an anchor point to at least one roof bolt situated above the fall zone; providing a safety line; associating the line with the anchor point; and attaching the line to an operator.

The safety line may be provided in the form of an inertia reel.

The safety line may be associated with the anchor point by attaching a hook to the anchor point.

The hook may include a gate which is operable from a distance by way of a pull cord.

In a second aspect the present invention provides a device for use in installing a safety line including: a hook; a spring loaded gate is associated with the hook; the gate is arranged to be opened from a distance.

The device may further include a generally elongate handle.

The handle may be adjustable in length by way of a telescoping action.

The device may further include a cradle, the cradle being arranged to receive and support an anchor point.

The cradle may include two upwardly projecting limbs.

The limbs may include recesses which receive and support the anchor point.

### BRIEF DESCRIPTION OF THE DRAWINGS

An embodiment of the present invention will now be described, by way of example only, with reference to the accompanying drawings, in which:

FIG. 1 is a perspective view of an embodiment of the invention;

FIG. 2 shows the hook attachment removed from the device of FIG. 1;

FIG. 3 shows the device of FIG. 1 with hook attachment removed;

FIG. 4 is a top view of FIG. 3;

FIG. 5 is an enlarged view of detail A of FIG. 3;

FIG. 6 illustrates how the cradle of the device of FIG. 3 receives a bow nut;

FIG. 7 shows the bow nut of FIG. 6 attached to an exposed end of a roof bolt;

FIG. 8 is a schematic view of a height safety system installed using the device of FIG. 1; and

FIG. 8 shows a release hook attachment for use with the device of FIG. 1.

### DETAILED DESCRIPTION OF THE PREFERRED EMBODIMENT

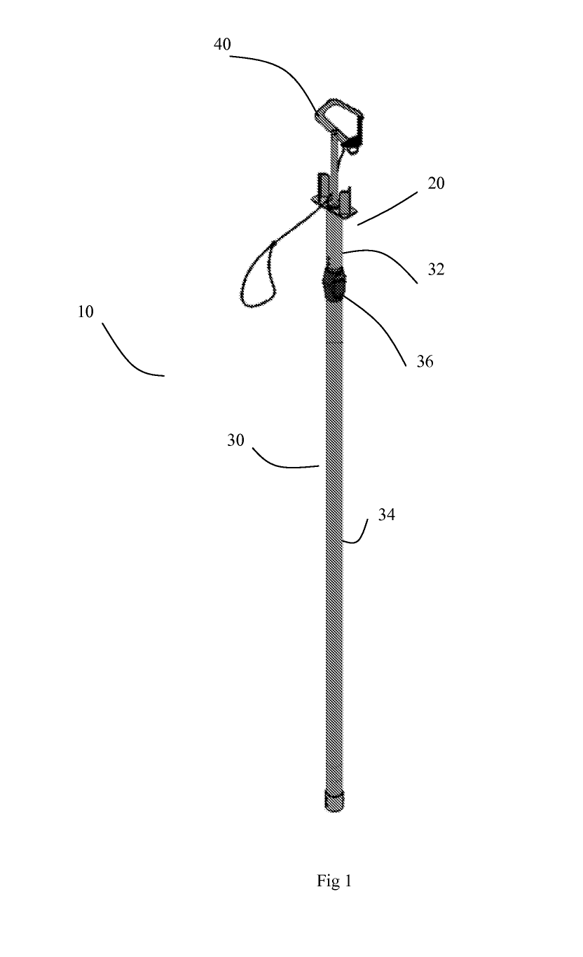

Referring to FIGS. 1, a device 10 for use in installing a safety line is shown including a hook 40. Device 10 further includes an elongate handle 30 which is formed from two members in the form of fibreglass tubes 32, and 34. Member 32 is a sliding fit inside member 34 and the two members are secured together by clamp 36. This arrangement allows the effective length of the handle 30 to be adjusted by releasing clamp 36, and sliding member 32 out of member 34 to a desired distance and retightening the clamp 36.

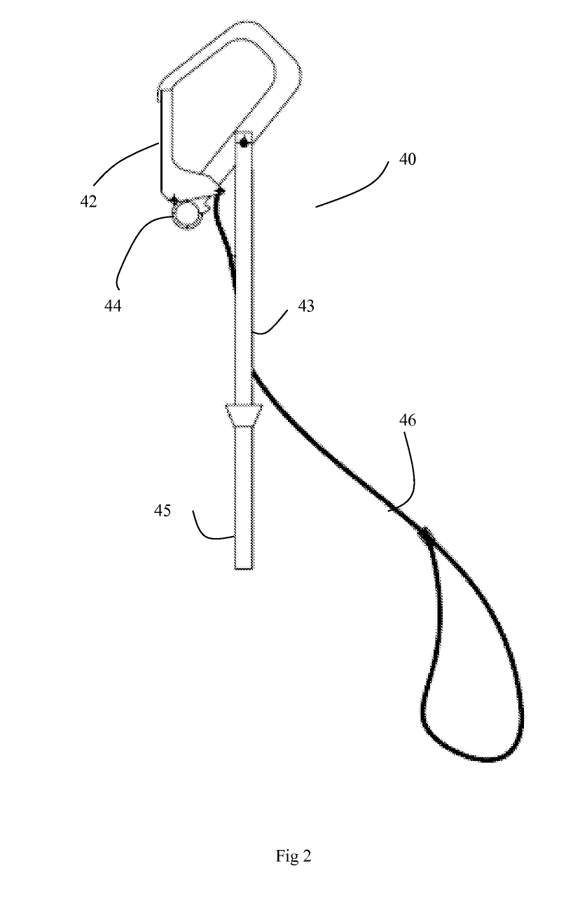

Referring to FIG. 2, hook 40 includes a spring loaded gate 42 and a pull cord 46 is provided which may be pulled to open the gate to allow the gate to be opened from a distance. The pull cord is threaded through the shaft 43 of hook. An eyelet 44 is provided to which a safety line may be attached as will be later described.

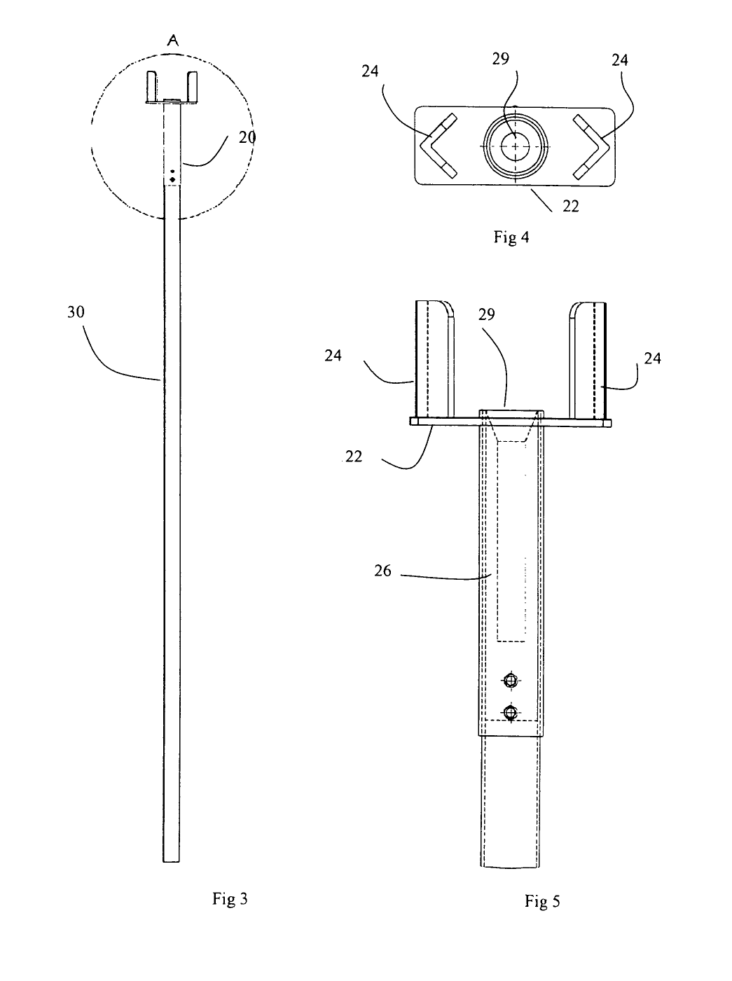

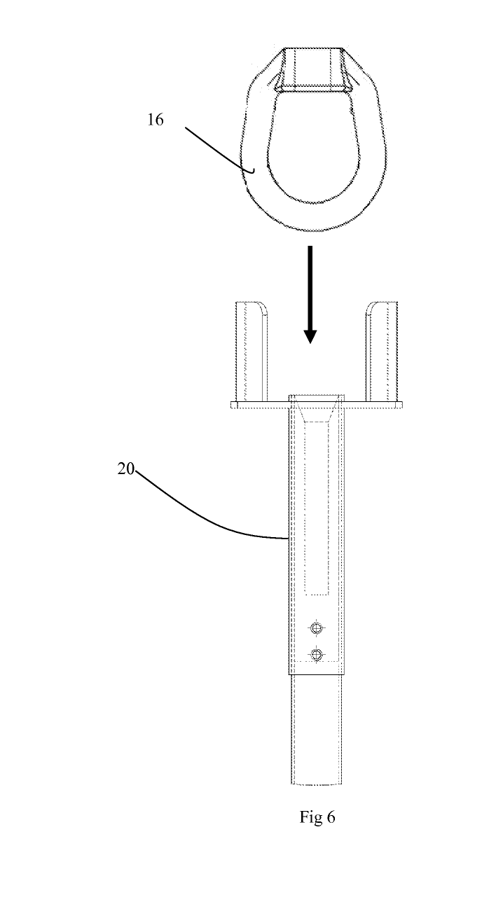

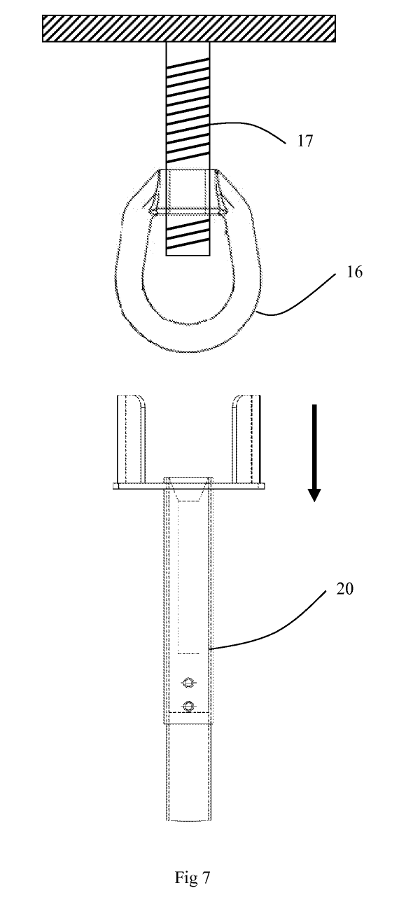

Hook 40 is removably mounted to handle 30 by way of shaft portion 45 being received with a sliding fit into a polythene bush. Referring to FIGS. 3 to 5, handle 30 is shown with the hook 40 removed. As best seen in FIG. 4, a polythene bush 26 is mounted inside the end of handle and includes a bore 29 which receives shaft portion 4.

Still referring to FIGS. 3 to 5, the device includes a cradle 20 which is formed from cross member 22 to which are mounted two upstanding limbs 24. These limbs include recesses 29. The cradle 20 receives and support an anchor point in the form of a bow nut 16.

Use of device 10 to install a height safety system using a mine roof bolt as an attachment point will now be described. The ceilings of mines are typically fitted with a very large number of closely spaced roof bolts. The bolts are inserted into the ceiling of the mine following a tunnelling operation. Nuts are tightened on the bolts which serve to support a roof plate against the roof of the mine to protect it from collapse and to reduce the likelihood of rocks falling from the ceiling of the mine. Approximately 150 mm of thread of the roof bolts is exposed below the roof plate. Roof bolts are typically rated to support a load of 20 tons.

In a first step, a bow nut 16 is attached to the exposed thread of one of the roof bolts. The roof bolts are located typically some 4 to 5 metres above the floor. In order to install the bow nut 16 from ground level handle 30 is used with the hook 40 removed.

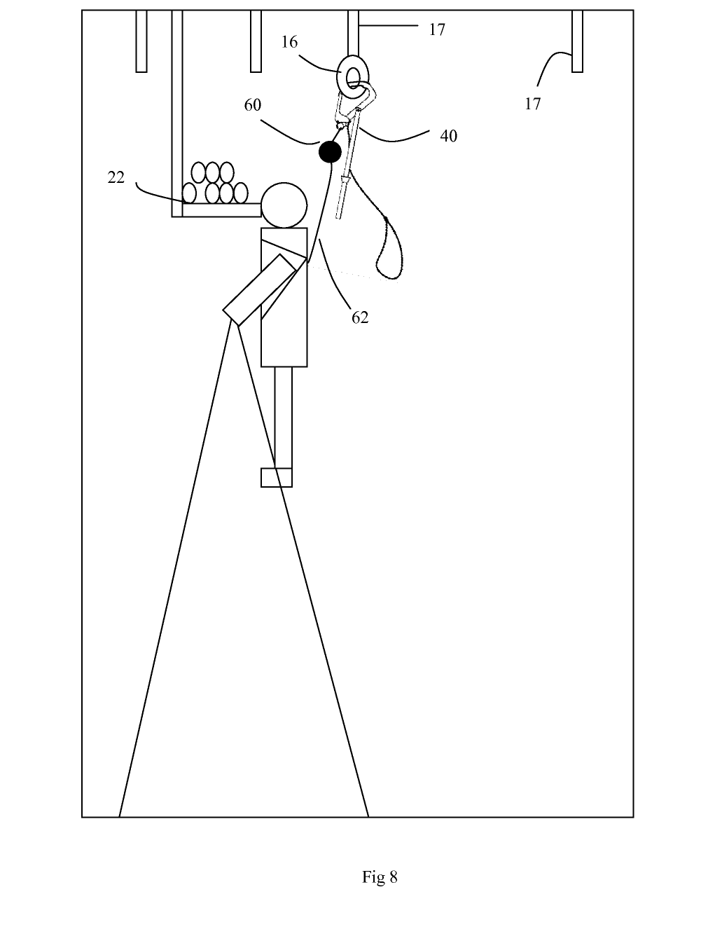

Referring to FIG. 6, the bow nut 16 is inserted into cradle 20. The length of handle 30 is adjusted as necessary and the handle is used to offer up the nut to an exposed roof bolt end overhead.

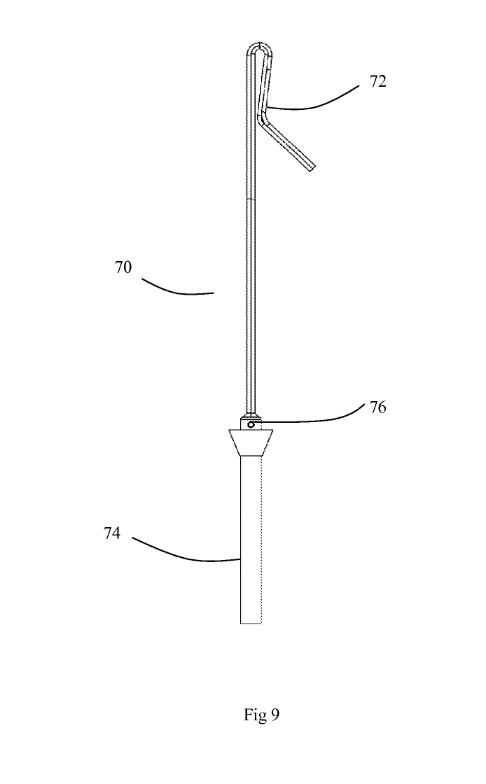

Referring to FIG. 7, the handle is rotated to thread the bow nut 16 onto the end of an exposed roof bolt end 17. Handle 30 is then withdrawn.

Hook 40 is then inserted into handle 30 as shown in FIG. 1 and a safety line is attached to eyelet 44 of hook. In a preferred embodiment a safety line is provided in the form of an inertial reel 60. The inertia reel is attached to eyelet 44 by way of a swivel. Then the free end of the safety line is attached to a harness of a worker. The handle 30 is used to offer up hook 40 to the bow-nut 16. As the hook is pushed upwards, the inertia reel unwinds. When at the correct height, by pressing the gate 42 of hook 40 against the bow nut 16, the gate 42 opens inwardly and the hook 40 is thus attached to the bow nut. The gate 42 closes with a return spring. The handle 30 is then withdrawn leaving the hook 40 attached to the bow nut, and the safety line is attached to eyelet 44 of hook 40.

An example of the resulting arrangement is shown schematically in FIG. 8. A worker is working at height to inspect a bundle of cables 22 that are suspended from a ceiling of an area in an underground mine. Bow nut 16 is attached to one of roof bolts 17. Hook 40 is attached to bow nut 16. Safety line inertia reel is attached to eyelet 44 of hook 40, and the worker is attached to the safety line by way of a harness. The worker is working at height on a ladder. It can be seen that, if the worker were to fall from the ladder for some reason, that the inertia reel would activate and prevent the worker falling to the floor below.

On completion of the inspection work, the hook 40 is removed from the bow-nut in the following manner. Referring to FIG. 9, a hook attachment 70 is shown. The hook attachment includes a hook 72 and a shaft portion 74. The shaft portion includes a through hole 76 to which is attached a second length of steel cable (not shown) of a similar gauge to the pull cord 46. The second length of steel cable is selected to be approximately the same length as the height of the work area. The shaft portion 74 is a sliding fit in the bore 29 of bush 28 of handle 30 in a similar manner to the hook 40. The hook attachment 70 is fitted to handle 30 and the hook 72 is used to catch and retain the looped end of pull cord 46. When hook portion 70 is attached to pull cord 46 the handle 30 is withdrawn and the second length of cable, which is inserted through hole 76, hangs down to ground level. Handle 30 is then offered back up to again receive shaft portion 45 of hook 40. Then, whilst pulling on the second length of steel cable to open gate 42, the handle is manipulated to free hook 40 from bow nut 16. The handle 40 is then brought to ground level.

Finally, hook 40 is again removed from handle 30 and cradle 20 is offered up to receive bow nut to unscrew the bow nut and lower the bow nut back to ground. The height safety system is now fully removed and can be re-used at another location.

Use of device 10 allows the height safety system to be installed by an operator who is standing at floor level. The roof bolts 17 are rated at 20 tons, and the bow nut is rated at 8 tons. The required strength of a single person fall restraint anchorage point is 1.5 tons according to New South Wales regulations.

It can be seen that embodiments of the invention provide at least the following advantages:
Use of pre-existing exposed roof bolts obviated the need for drilling or inserting anchor points thus saving time and components.
System can be installed from floor level and thus there is no risk of falling during installation of the system

Embodiments of the invention have application in other scenarios that do not rely on use of exposed roof bolts. All that is required is a loop or other formation to which the hook 40 can be attached.

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1. A method of installing a height safety system in a fall zone in an underground location including the steps of:
fitting an anchor point to at least one roof bolt situated above the fall zone; providing a safety line;
associating the line with the anchor point; and
attaching the line to an operator.

2. A method according to claim 1 wherein the safety line is provided in the form of an inertia reel.

3. A method according to claim 2 wherein the safety line is associated with the anchor point by attaching a hook to the anchor point.

4. A method according to clam 3 wherein the hook includes a gate which is operable from a distance by way of a pull cord.

5. A device for use in installing a safety line including:
a hook;
a spring loaded gate is associated with the hook;
the gate is arranged to be opened from a distance.

6. A device according to claim 5 further including a generally elongate handle.

7. A device according to claim 6 wherein the handle is adjustable in length by way of a telescoping action.

8. A device according to claim 5 further including a cradle, the cradle being arranged to receive and support an anchor point.

9. A device according to claim 7 wherein the cradle includes two upwardly projecting limbs.

10. A device according to claim 7 wherein the limbs include recesses which receive and support the anchor point.
